(19) United States
(12) Patent Application Publication
(10) Pub. No.: US 2025/0028766 A1
(43) Pub. Date: Jan. 23, 2025

(54) DISCOVERING CONTACTS AND INFERRING OWNERSHIP OF EXTERNAL-FACING ASSETS

(71) Applicant: Palo Alto Networks, Inc., Santa Clara, CA (US)

(72) Inventors: Pamela Lynn Toman, Campbell, CA (US); Andrew Clayton Scott, Westfield, IN (US); Johnathan Daniel Wilkes, Laurel, MD (US); Aaron Mark Isaksen, Booklyn, NY (US); Matthew Stephen Kraning, San Francisco, CA (US); Gregory David Heon, San Francisco, CA (US)

(21) Appl. No.: 18/353,298

(22) Filed: Jul. 17, 2023

(51) Int. Cl. G06F 16/9535; G06F 16/9538

(52) U.S. Cl. CPC G06F 16/9535; G06F 16/9538

(57) ABSTRACT

A data-driven, unsupervised system (“owner inference module”) has been created that collects information from different data sources and infers ownership of an asset by discerning signals conveying ownership and using them to identify likely owners of assets. The owner inference module creates a graph of direct and indirect relationships among the asset and entities based on the collected information (i.e., the data and metadata). The owner inference module processes the graph and accounts for the varying strengths of different ownership signals based on any one or more of observations, expert knowledge, and preferences. The owner inference module quantifies the different signals of ownership of an entity and aggregates these values into an ownership likelihood score.

### BACKGROUND

The disclosure generally relates to electrical digital data processing (e.g., CPC G06F), attack surface management (e.g., CPC G06F 21/57), and data processing (e.g., CPC G06F 17/00).

The National Institute of Standards and Technology (NIST) special publication 800-207 provides a brief history of the term “zero trust” and explains that zero trust is a “paradigm focused on resource protection and the premise that trust is never granted implicitly but must be continually evaluated.” This NIST special publication also provides guidelines for enterprises implementing a Zero Trust architecture. These guidelines indicate that a Zero Trust architecture implementation should include external attack surface management. The NIST computer security resource center glossary defines attack surface as “The set of points on the boundary of a system, a system element, or an environment where an attacker can try to enter, cause an effect on, or extract data from, that system, system element, or environment.” External attack surface management involves continuous discovery of Internet-facing assets of an enterprise and risk assessment of the discovered assets to facilitate remediation.

### BRIEF DESCRIPTION OF THE DRAWINGS

Embodiments of the disclosure may be better understood by referencing the accompanying drawings.

FIG. 1 depicts a diagram of a system that infers ownership of assets based on information from multiple data sources.

FIG. 2 is a flowchart of example operations for inferring likely user owners of an asset.

FIG. 3 is a flowchart of example operations for identifying entities related to an asset up to a distance limit and recording information about relationships obtained from data sources.

FIG. 4 is a flowchart of example operations to query data sources and, based on responses, identify entities related to a query target and record relationship information in a graph.

FIG. 5 is a flowchart of example operations for analyzing relationship properties of each entity that is a contact to determine values of the relationship properties.

FIG. 6 depicts an example computer system with an owner inference module.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness. The examples refer to Internet-facing/external-facing assets within the context of the examples provided to aid in understanding the disclosed technology. Embodiments are not so limited and the disclosed technology can be used to infer ownership of digital assets that are not Internet/external-facing assets.

### Overview

External attack surface management includes external discovery of Internet-facing (also referred to as “external-facing”) assets and organizational ownership of those assets. While this information facilitates attack surface management, a gap remains between discovering these assets and managing security issues of discovered assets forming the attack surface. Ownership information would fill this gap and facilitate managing security issues (e.g., authorizing remediation, implementing fixes, etc.) of external attack surface management (EASM) discovered assets. “Ownership” of an asset refers to responsibility or accountability of the asset, including security issues. An owner may be an asset owner or a risk owner depending on organizational implementation. In this description, “owner” refers to a contact (i.e., an entity that can be communicatively contacted) that has ownership of an asset. This is distinct from “organization owner” and “organizational ownership” which refers to ownership of an asset by an organization (i.e., company, business, government, etc.). Within an organization, identifying owners can be problematic for various reasons (e.g., organizational changes, decentralized information, etc.).

A data-driven, unsupervised system has been created that collects information from different data sources and infers ownership of an asset by discerning signals conveying ownership and using them to identify likely owners of assets. While the vast amount of data and metadata that exists for assets of an organization can yield numerous signals, many of these signals are weak. Furthermore, the amount of data and metadata and dynamic nature of its generation also yields noise. The data-driven, unsupervised system for identifying owners of assets (“owner inference module”) uses an aggregate of weak signals derived from collected information across different data sources as a collective attestation of user ownership. The owner inference module creates a graph of direct and indirect relationships among the asset and entities based on the collected information (i.e., the data and metadata). The owner inference module records information about the relationships into the graph. The relationship information includes various properties of relationships, some of which are based on external application programming interface (API) calls made to collect the information and content of the responses. The relationship(s) between an entity and the asset and properties of the relationship are the signals of user ownership. The owner inference module processes the graph and extracts the signals of ownership (i.e., values of the relationship properties). In addition, the owner inference module can account for the varying strengths of different ownership signals based on any one or more of observations, expert knowledge, and preferences. The owner inference module quantifies the different signals of ownership of an entity and aggregates these values into an ownership likelihood score. Entities determined to be likely owners of the asset are presented as contacts for communicating events (e.g., a detected vulnerability or alert).

### Example Illustrations

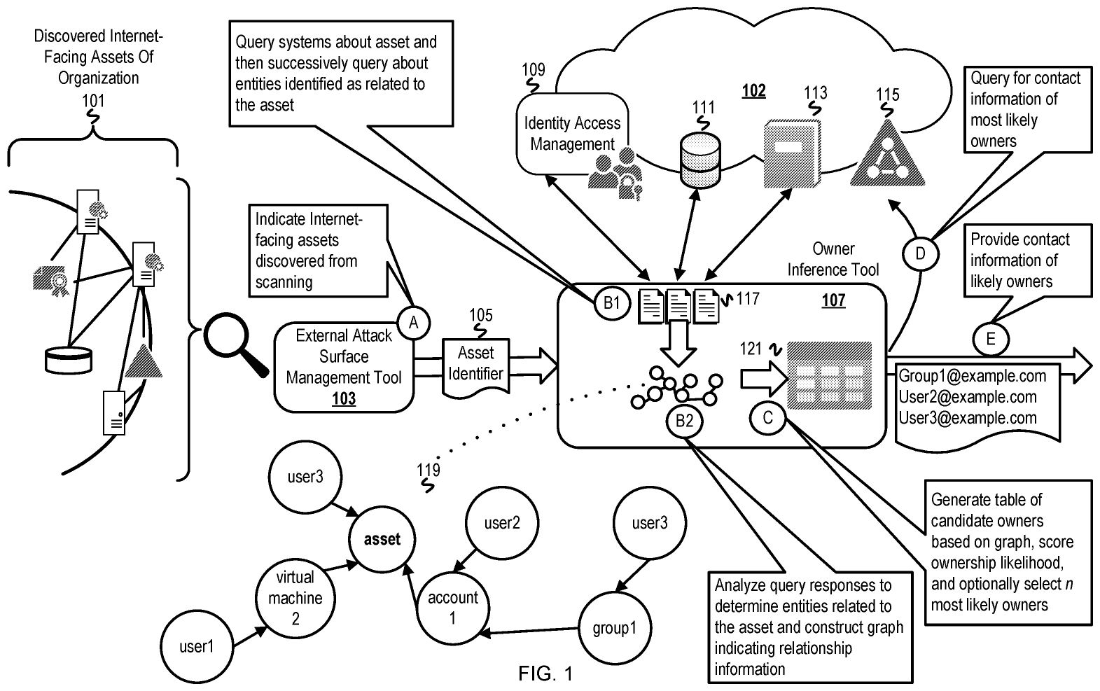

FIG. 1 depicts a diagram of a system that infers ownership of assets based on information from multiple data sources. An external attack surface management (EASM) tool 103 communicates with an owner inference module 107. Implementations can incorporate the owner inference module 107 into the external attack surface management tool 103. The EASM tool 103 scans the Internet to discover Internet-facing or external-facing assets identified by network addresses, network addresses and ports, uniform resource locators (URLs), etc. Examples of external or Internet-facing assets include domains, servers, ranges of network addresses, certificates, and services. In FIG. 1, external-facing assets 101 have been discovered by the EASM tool 103.

FIG. 1 is annotated with a series of letters A, B1, B2, and C-E representing stages of operations, each of which corresponds to one or more operations. Although these stages are ordered for this example, the stages illustrate one example to aid in understanding this disclosure and should not be used to limit the claims. Subject matter falling within the scope of the claims can vary from what is illustrated.

At stage A, the EASM tool 103 indicates to the owner inference module 107 an asset identifier in a notification 105. In this example, the EASM tool 103 communicates a message (e.g., an alert or notification) that indicates an asset identifier (e.g., network address) to the owner inference module 107 when the asset is discovered during scanning. The owner inference module 107 can be designed to concurrently process notifications from the EASM tool 103 or work on a queue of asset identifiers.

Stage B1 begins before B2 but the operations thereof can subsequently overlap. At stage B1, the owner inference module 107 queries data sources 109, 111, 113 about the discovered asset and obtains query responses 117. The owner inference module 107 has been configured to interact with data sources 109, 111, 113. FIG. 1 depicts the data sources 109, 111, 113 respectively as an identity access management system, a configuration management database, and a cloud service log. FIG. 1 depicts a network 102 hosting the data sources 109, 111, 113 as a simple example. However, the data sources can be hosted by different cloud service providers, on-premises, in private clouds, etc. At stage B2, the owner inference module 107 analyzes the query responses 117 to determine entities related to the asset and constructs a graph 119 indicating relationship information. Based on the analysis, the owner inference module 107 successively queries the data sources 109, 111, 113 about entities identified as related to the asset up to a defined relationship distance (B1). The owner inference module 107 analyzes the responses to the successive queries and updates the graph 119 (B2) with additionally learned relationship information. The successive queries are for related entities that are not individual contacts, such as group contacts and machine entities (e.g., a compute instance, container, virtual machine). In addition, the owner inference module 107 uses natural language processing on responses from the log 113 to identify terms that may correspond to entities that are related to an asset or relate a contact to the asset. The owner inference module 107 would then generate queries about the identified terms to ascertain whether the term identifies an entity related to the asset and, if so, relationship information.

The graph 119 indicates a root node that represents the asset. Nodes representing a user3, account1, and virtualmachine2 are directly related to the asset and have a relationship distance of 1. A node representing a user2 and a node representing group 1 are related to the asset via the account1 node, thus having a relationship distance of 2. The entity user3 is represented by another node in the graph 119 related to the group1 node, thus having a distance relationship of 3 with the asset. A node representing the entity user1 is related to the virtualmachine2 node and has a relationship distance of 2 with the asset node. The user1, user2, user3, and group1 are entities that are contacts and therefore have contact information (e.g., a phone number or email address). The group1 entity is a group of users or distribution group. The account1 entity is a digital identity for an application or service to interact with other applications or an operating system. The virtualmachine2 entity is a virtual machine that can be used to execute, create, contain, etc. an asset. The digital identity and virtual machine entities are not contacts. The owner inference module 107 can determine relationships from indications in the query responses of transactions corresponding to the asset (e.g., create, read, edit, view, etc.), permissions, roles, etc. As an example, the query responses indicate that account1 created the asset when user2 was using account1. These relationships would be discerned from the log 113 and the identity access management system 109 and together lead the owner inference module 107 to update the graph 119 to indicate that account1 has a direct relationship with asset and that user2 has a direct relationship with account1. Thus, the indirect relationship that user2 has with the asset via account1 is a basis for an inference of ownership relationship by user2 with asset. Whether or not user2 will be identified as a likely owner will depend on the additional analysis of other entities with inferred ownership relationships.

At stage C, the owner inference module 107 generates a table of candidate owners based on the graph 119. The owner inference module 107 extracts the relationship information of entities that are contacts (i.e., individual contacts and group contacts) in the graph 119 into a scoring structure 121, depicted as a table. The owner inference module 107 indicates each contact in the graph 119 along a first dimension of the table 121 (e.g., row). The owner inference module 107 then analyzes each relationship to determine the properties of the relationship in the graph 119 and records the values of the properties for each contact in the table 121. Example relationship properties include relationship type, number of relationships, number of different types of relationships, shortest relationship distance, whether a contact has a common attribute with the asset (e.g., similar name), and which data source(s) provided the data that was a basis for indicating a relationship. For example, a data source may be recognized as an authoritative data source (e.g., a configuration management database) and the data source relationship property can be a binary value (e.g., authoritative or not). As another example, different values or weights can be assigned to the different data sources and aggregated into a value for the data source relationship property. To determine the property values, the owner inference module 107 traverses the graph 119 from the asset node to each leaf node, which should correspond to a contact, and records into the table 121 the information determined from the graph 119. Examples of recording information extracted from the graph 119 include recording a data source descriptor attached to an edge of the graph 119 into the table 121 and counting edges traversed. After extracting the relationship information from the graph 119, the owner inference module 107 scores likelihood of ownership for each of the candidate owners. For each contact indicated in the table 121, the owner inference module 107 calculates a score based on the values of the relationship properties. The owner inference module 107 then selects the top n most likely owners according to the scores.

At stage D, the owner inference module 107 queries a directory service 115 for contact information of the selected n most likely owners of the asset. Depending on implementation, the contact information can be one or more of e-mail addresses, phone numbers, first/last name, title, office location, time zone, and messaging application identifiers. In this example, n=3 and the top 3 likely owners are group1, user2, and user3. The corresponding contact information obtained from the directory service 115 are group1@example.com, user2@example.com, and user3@example.com. This stage presumes that the identifiers of the selected contacts are not themselves contact information.

At stage E, the owner inference module 107 provides the contact information of the top n most likely owners for recording into a system. The recipient system of the contact information depends upon implementation. The contact information may be recorded into a database of discovered assets or into a help desk system or information technology ticketing system, as examples. If indication of the asset arose from an alert or notification of vulnerability or coincident with EASM scanning, the contact information could be used to communicate the alert or notification to the likely owners.

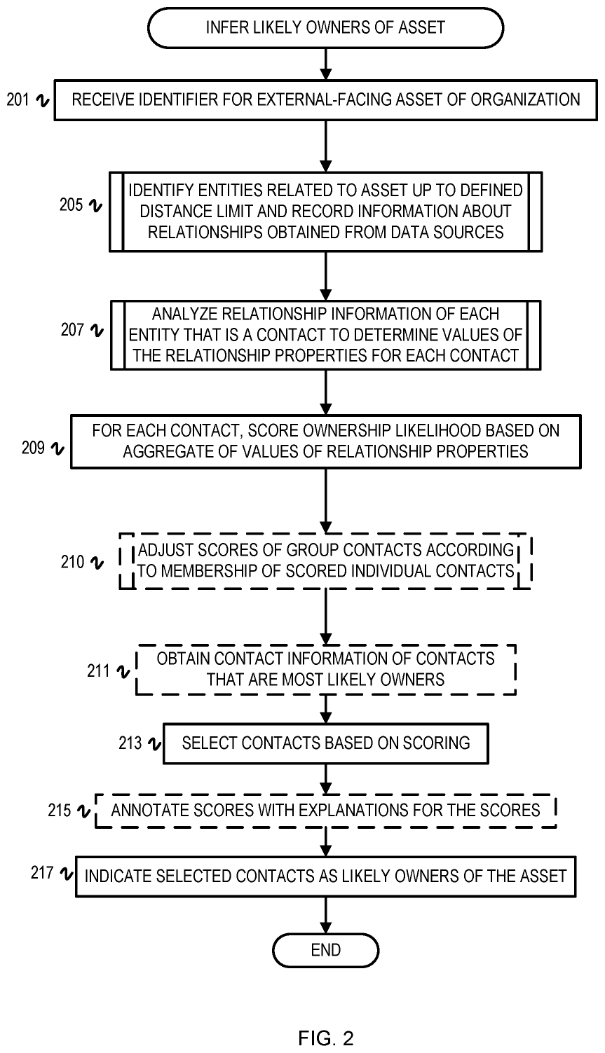

FIGS. 2-5 are flowcharts of example operations for different aspects of inferring asset ownership in more general terms than the example illustrated by FIG. 1. For consistency with FIG. 1, the example operations of the flowcharts are described with reference to an owner inference module.

FIG. 2 is a flowchart of example operations for inferring likely owners of an asset. If integrated as part of EASM scanning or run in coordination with scanning, these operations can be run repeatedly as each external-facing asset is discovered.

At block 201, the owner inference module receives an identifier for an external-facing asset of an organization. “External-facing” refers to an asset being accessible from at least outside of a network in which the asset resides, which may mean the asset is publicly accessible. The asset identifier may be received via in-process communication, shared memory locations, or network message.

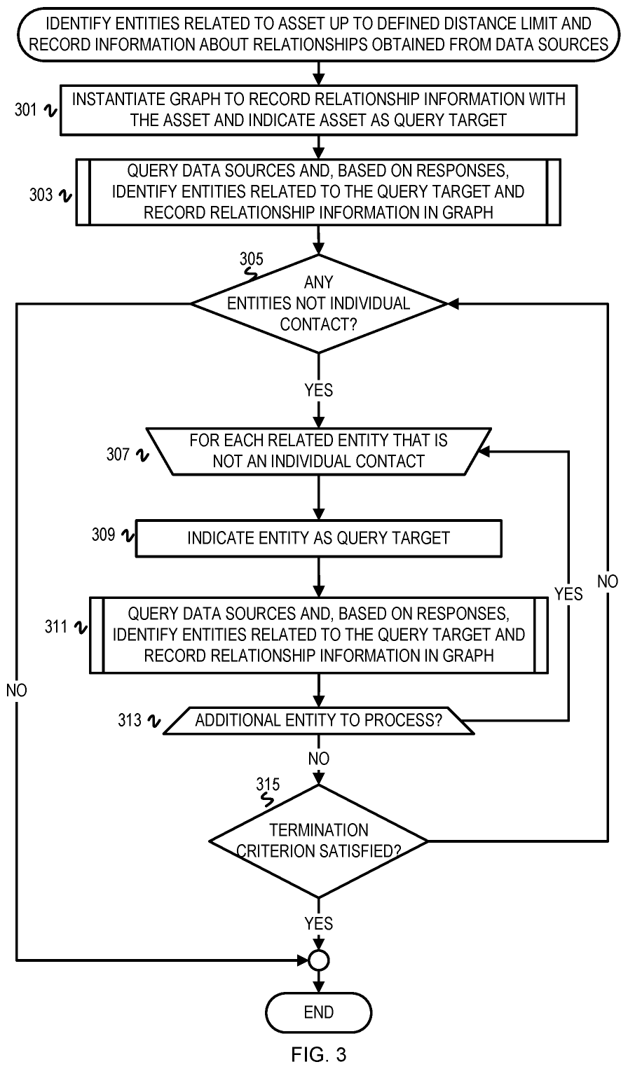

At block 205, the owner inference module identifies entities related to the asset up to a defined distance limit based on information obtained from data sources. The owner inference module records the relationship information in a graph for later analyzing to discern likelihood of ownership. “Graph” refers to the abstract data type structure that can be used for indicating entities and relationships among the entities. Implementations can vary as to the data structure(s) for implementing a graph. Example operations for block 205 are depicted in FIG. 3.

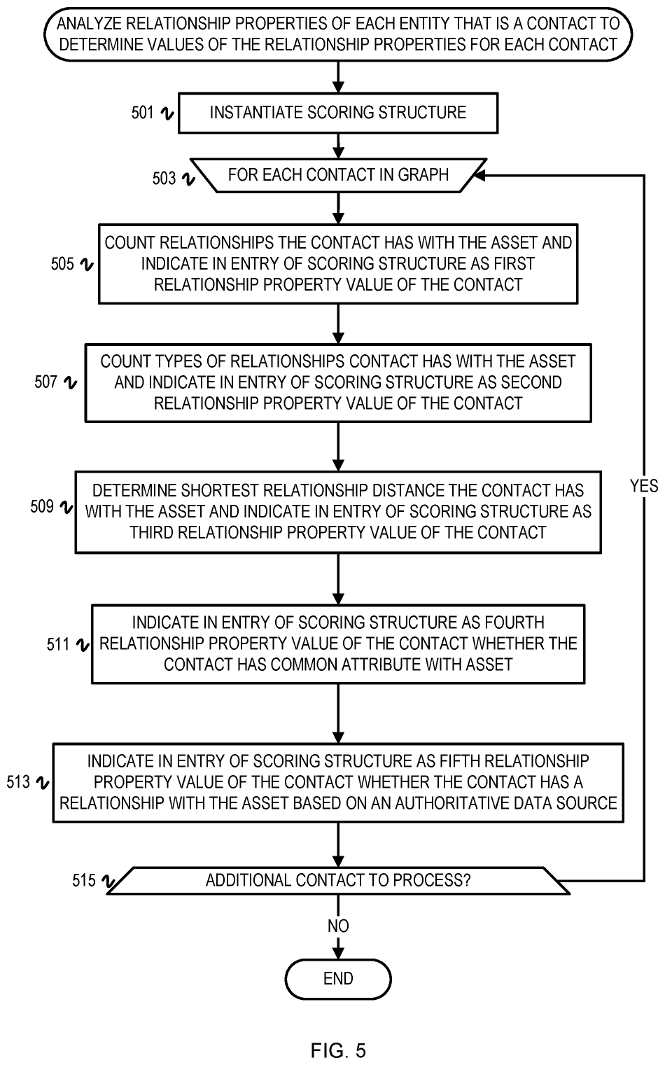

At block 207, the owner inference module analyzes the relationship information to determine values of relationship properties of each entity. Each entity can have one or more relationships with an asset. There can be multiple instances of a same relationship type. For instance, logs may indicate invocations of an asset which would be multiple instances of a transactional type of relationship. A response from an identity and access management (IAM) system may indicate that a user entity has an administrator role of the asset. The different properties can be considered different signals, and the owner inference module can be considered as processing multiple signals of ownership. Example operations for block 207 are depicted in FIG. 5.

At block 209, the owner inference module scores ownership likelihood for each entity that is a contact, based on an aggregate of the values of the relationship properties of the contact. While recording information into the graph, the owner inference module can include indication of whether an entity is a group contact or individual contact. The owner inference module can determine whether an entity is a contact as the entity is being recorded into the graph with a query to a directory or traverse the graph after construction to make the determination. The scoring by the owner inference module quantifies the likelihood of ownership of an asset by a contact (i.e., likelihood that the contact is responsible, accountable, etc. for the asset). The owner inference module can be configured to weigh a property based on subject matter expertise and/or observations. As examples, the owner inference module can be configured to weigh number of relationships more heavily than shortest distance of relationship. Likewise, owner markers such as having a relationship based on data from an authoritative data source can have a greater weight than number of relationships. Embodiments can adjust weights based on subsequent observations, changes in data sources, etc. For instance, weights can be adjusted based on observations of common properties among inferred user owners that have been confirmed as owners.

At block 210, the owner inference module adjusts scores of group contacts that are candidate owners according to membership of scored individual contacts. Group contacts are included as candidate owners to expand the fields of potentials owners which increases the probability of reaching someone who can address an issue related to the asset. A group may have other members not identified as likely owners. Also, membership of high scoring individual contacts can increase the likelihood that a group is an owner. The owner inference module separately ranks individual contacts and group contacts by scores. The owner inference module can then adjust the score of a group contact based on the scores of individual contacts that are members of the group. After adjusting the scores of group contacts, the candidate owners can be re-ranked. Implementations can subsume individual contacts into groups or preserve listing of both a group contact and scored individual contacts that are members. Block 210 is depicted in a dashed line to indicate it being optional.

At block 211, the owner inference module obtains contact information of contacts likely to be owners of the asset. Block 211 is depicted as an optional block since some or all of the contacts may already be identified with a contact identifier. The owner inference module can query a company directory to obtain the contact information or any other data source with contact information for the organization.

At block 213, the owner inference module selects from the scored contacts based on the scoring. Selection of the scored contacts can be implemented differently. For example, the owner inference module can be programmed to select the contacts with the highest n scores and indicate them as likely owners of the asset. However, limiting to the top n is not necessary. In addition to or instead of choosing the contacts with the top n scores, all identified contacts can be selected or thresholding can be applied. As an example, the owner inference module can select contacts with a score in a top range without a selection limit. As another example, the owner inference module can select contacts starting in a top score range and proceeding down successively lower ranges until either selecting a defined n contacts or a lowest acceptable score is reached. Thresholding can also be data-driven. For instance, the owner inference module can perform relative selection and select the highest scoring contacts within a defined proximity of each other or the highest scoring users above a “gap” (i.e., defined maximum difference between consecutive scores).

At block 215, the owner inference module annotates selected contacts with “explanations” for the scores. The explanations would be based on the relationship properties contributing to the scoring. Labels for the properties and corresponding values can be presented or expository descriptions. For instance, an explanation can be presented as “role: admin from CMDB; relationship distance:2” or “This user entity is defined as an administrator of Project X, in which the asset was created.” The bulk of explanations can be extracted from the data obtained from the data sources (e.g., transaction logs, comments in tickets, etc.). The information can be used to populate template explanations or input into a text generator that can form sentences from the pieces of information inserted into a prompt, for example. Embodiments can also include confidence as part of an explanation or as additional information about the score. Confidence can be calculated based on heuristics. A heuristic may have been defined based on an observation about gap size that defines likely owners or team members. A confidence heuristic may provide a confidence value or component value based on the proportion of users in a group that are high scoring relative to a defined limit or distribution of scores (e.g., top 10% of scores). Block 215 can be optionally performed and is therefore depicted in a dashed line.

At block 217, the owner inference module indicates the selected contacts as likely owners of the asset. Indication of the selected contacts can be forwarding an alert/notification to the user entities using the contact information of the contacts. When creating the indication of the selected contacts, the inference owner module can surface the explanations with the indications or associate the explanations that can be presented upon selection or request (e.g., as pop-up information triggered by an event associated with each contact, retrieval from a database and presentation of the explanations upon request or activation in a notification, etc.).

FIG. 3 is a flowchart of example operations for identifying entities related to an asset until a termination criterion is satisfied and recording information about relationships obtained from data sources. The termination criterion depends on how an embodiment measures relationships. For instance, implementations can define the termination criterion in terms of distance and/or non-distance-based strength. The majority of the description presumes a distance based measurement of relationships to aid in explaining the technology and since distance is intuitive for a graph.

At block 301, the owner inference module instantiates a graph to record relationships with the asset and indicates the asset as query target. The owner inference module instantiates the graph with a node or entry for the asset as the root. The owner inference module constructs queries for data sources indicating the query target. Initially, the owner inference module sets the asset as the query target.

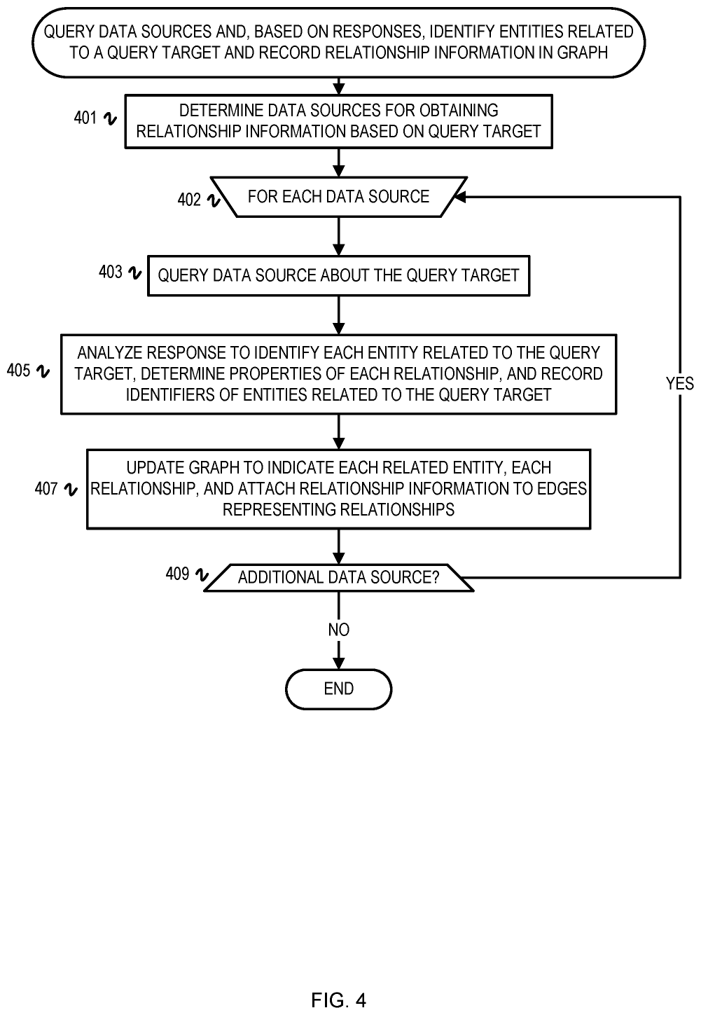

At block 303, the owner inference module submits queries to data sources to obtain ownership information. Based on query responses, the owner inference module identifies entities related to the query target and records relationship information into the graph. Example operations for block 303 are depicted in FIG. 4.

At block 305, the owner inference module determines whether any of the identified entities is not an individual contact, such as an entity for machine-to-machine communications and/or transactions or a distribution list. If at least one of the entities identified as related to the asset is not an individual contact, then operational flow proceeds to block 307. Otherwise, operational flow for FIG. 3 ends. With reference to FIG. 2, operational flow would proceed to block 207 after the example operations of FIG. 3 end.

At block 307, the owner inference module begins processing each of the entities identified as related to the asset that is not an individual contact. When identifying entities related to the asset, the owner inference module can maintain a listing in memory of the entities that are not individual contacts and traverse this listing, as one example implementation.

At block 309, the owner inference module indicates the entity as a query target. The owner inference module sets the identifier of the entity as the argument for the query target parameter.

At block 311, the owner inference module submits queries to data sources to obtain ownership information about the entity indicated as the query target. The one or more successive queries for entities having either direct or indirect relationships as determined from prior query responses with known structure allow the owner inference module to collect more relationship information and identify other entities related to the asset. For possible entities determined from significant terms, the queries collect information to affirm the determination that the term identifies an entity, collect potential relationship information, and identify other entities or terms that may identify entities related to the asset. As with 303, FIG. 4 provides example operations to implement 311.

At block 313, the owner inference module determines whether there is an additional entity to process. If there is another entity, then operational flow returns to block 307. If there is not another entity to process, then operational flow proceeds to block 315.

At block 315, the owner inference module determines whether termination criterion is satisfied. The termination criterion is set to obtain sufficient information to support an inference of ownership of an asset while regulating resource consumption. Examples of a termination criterion defined in terms of distance include number of edges in a path to the asset node and number of intermediary nodes in a path to the asset node. Examples of a termination criterion defined in terms of relationship strength include a minimum non-distance strength calculated for a path. A termination criterion can be based on both distance and non-distance strength. For example, a termination criterion can be defined as a distance that is a function of path strength with farther distance for termination (i.e., more rounds of discovery) when path strength is weaker (e.g., below a path strength threshold). Path strength can be calculated based on the data supporting a relationship inference. Examples include calculating strength of a relationship from number of distinct logs in a time window that indicate a contact in relation to the asset and calculating strength from a sequence of different transactions indicating the contact. The calculation of a path strength can use one or more weights assigned to each edge in the path, with the weights being based on the data supporting a relationship inference(s) corresponding to the edge. If the limit has been reached, then operational flow ends. Otherwise, operational flow returns to block 305 for processing of entities identified in the current iteration. In other words, the entities or terms that might identify entities determined from analyzing query responses in the current iteration of block 311 will be query targets in the next iteration. To illustrate, a response to an IAM request may indicate user1 has access to asset1. The owner inference module then queries a cloud platform for entries in a log that indicates both user1 and asset. The owner inference module determines whether the log query response indicates users based on formatting (e.g., an email address format). The owner inference module also uses natural language processing to identify significant terms. The owner inference module can filter identified significant terms with heuristics to remove terms defined as not possible contacts or machine entities that would relate contacts to the asset. For example, the natural language processing of the log query response identifies “mapper_tool” and “key” as significant terms but filters out key. The owner inference module then sets “mapper_tool” as a query target and queries the log again or another data source.

FIG. 4 is a flowchart of example operations to query data sources and, based on responses, identify entities related to a query target and record relationship information in a graph. As depicted in the earlier flowcharts, the operations of querying and identifying repeat for multiple rounds of identifying/discovering entities related to the asset. Each round of discovery is not necessarily at a next distance of relationship. For instance, responses from querying transaction logs or platform logs may yield an individual contact that created an asset or set administrative privileges on an asset. Each of these would be a different relationship at a same distance.

At block 401, the owner inference module determines data sources for obtaining ownership information based on the query target. One set of data sources is defined in a configuration file or settings of the owner inference module. An administrator of the organization will have provided authorization for the owner inference module to query the data sources. Schema and/or structure of the responses will be defined for the owner inference module to facilitate parsing the query responses and extracting relationship information. The administrator or organization can also provide access to other data sources that could be queried depending upon the identified entities or round of entity discovery. For instance, the owner inference module can be granted access to query multiple logs across different cloud service providers. The owner inference module would determine which data sources to query based on the query target, which may be a term deemed an entity or a confirmed entity. The owner inference module would then construct a query according to the data source. The owner inference module can be programmed or configured to initially query a first set of data sources and then dynamically determine data sources to query thereafter based on the query target.

At block 402, the owner inference module begins processing each data source determined to be queried by the owner inference module. At block 403, the owner inference module queries a data source about the query target. The owner inference module can maintain at least one query template for each data source. When a query template is selected, the owner inference module populates the selected template with an asset identifier or entity identifier as the query target argument.

At block 405, the owner inference module analyzes the response to the query to identify each entity related to the query target and determines properties of each relationship. In addition, the owner inference module determines whether any of the related entities are individual contacts or not and tracks the identifiers of the entities that are not individual contacts to be subsequent query targets. The analysis involves parsing the query response based on the known schema or structure of the query response and extracting values assigned to keywords or tags identifying fields previously determined as corresponding to relationship properties. Some of this analysis can rely on “verbs” which can be one or more terms that indicate a fundamental relationship. As an example, the owner inference module queries an IAM system for information about an asset and receives a response that indicates the entities having roles and/or permissions related to the asset. The combination of the data source being an IAM system and the query response indicating an entity having an administrator role can together be treated by the owner inference module as an implied verb of ownership. As another example, the user owner queries a cloud service provider log to obtain transactions that indicate the asset. The owner inference module will search for explicit verbs linking the asset to an acting entity. Examples of explicit verbs in a log query response indicating a relationship include create, edit setting, start, creating a user, and share. In addition, the owner inference module can identify “interesting” terms as possible entities. The owner inference module may analyze a query response (e.g., a comment section of a ticket or an audit log) to identify interesting/important terms as possible entities using natural language processing, such as term frequency-inverse document frequency (TF-IDF). The owner inference module can then query data sources to determine whether there is a relationship with the asset, perhaps querying for records or log entries in which the asset identifier and the interesting entity term occur.

At block 407, the owner inference module updates the graph to indicate each related entity, each relationship, and the discovered relationship information. The owner inference module will add an edge and node to indicate an entity related to the query target. The owner inference module will also attach other information about relationship properties to the edge, such as relationship type, verb, and data source descriptor. The owner inference module may also attach to the node information about the entity, such as whether it is a group contact, individual contact, or not a contact.

At block 409, the owner inference module determines whether there is an additional data source determined for the query target. If there is an additional data source, then operational flow returns to block 402. Otherwise, operations end for FIG. 4.

FIG. 5 is a flowchart of example operations for analyzing relationship properties of each entity that is a contact to determine values of the relationship properties. With the relationship information from the data sources recorded into a graph, the owner inference module traverses the graph to determine the relationship property values. Implementations can program the owner inference module to have configurable scoring, thus allowing different properties to be considered in scoring or quantifying likelihood of ownership. FIG. 5 refers to a few example relationship properties to aid in understanding the technology. Also, task breakdown for extracting values of properties from the graph can vary by graph implementation, programming language, execution environment, etc. As examples, the owner inference module can traverse the graph according to a breadth first search algorithm or depth first search algorithm to extract information.

At block 501, the owner inference module instantiates a scoring structure. The scoring structure is instantiated to facilitate the scoring which involves aggregating values of relationship properties. As an example, the owner inference module can instantiate a table with a column for each relationship property considered as impacting owner likelihood scoring. As each contact is encountered, the owner inference module can add an entry/row to the scoring structure. As mentioned earlier, the relationship properties can be considered the signals indicating possible ownership of an asset. While the owner inference module does not rely on an individual signal as attestation of ownership, the owner inference module can use the collective signals or signals in aggregate to infer ownership.

At block 503, the owner inference module begins processing each contact in the graph to determine relationship property values. The owner inference module does not consider the entities that are not contacts as candidate owners but records them into the graph when discovering entities that can relate to the asset. While traversing the graph, the information about a related entity that is not a contact is considered information about the relationship of a contact related to the asset via the non-contact entity.

At block 505, the owner inference module counts relationships the contact has with the asset and indicates the count in an entry of the scoring structure as a value for a first relationship property. A user entity may have multiple nodes in graph structure based on having different relationship paths, for example being related through different non-contact or group contact entities. A structure may maintain separate edges for each relationship or attach information to the edge indicating each verb that is the basis for the relationship and a count for each verb encountered that is the basis for the edge. The owner inference module maintains the count in the scoring structure and updates the entry as the owner inference module traverses the graph.

At block 507, the owner inference module counts types of relationships the contact has with the asset and indicates the count in an entry of the scoring structure as a value for a second relationship property. Similar to counting relationships regardless of types, the owner inference module can maintain a count as it encounters a different relationship type.

At block 509, the owner inference module determines a shortest relationship distance the contact has with the asset and indicates it in an entry of the scoring structure as a value for a third relationship property. While traversing the graph, the owner inference module can track lengths of paths, assuming more than one, to a contact from the asset node.

At block 511, the owner inference module determines whether the contact has a common attribute with the asset and indicates that determination, for example as a binary flag, in an entry of the scoring structure as a value for a fourth relationship property. A common attribute could be name, for example a substring in the asset name can match a substring of a contact name. Another example of a common attribute would be “team” within an organization.

At block 513, the owner inference module determines whether the contact has a relationship with the asset based on data from an authoritative data source and indicates this in an entry of the scoring structure as a value for fifth relationship property. As an example, an IAM system can be considered an authoritative data source. An indication in a response from the IAM system that a user entity is an author or administrator of an asset could be considered an ownership marker.

At block 515, the owner inference module determines whether there is an additional contact to process. If there is an additional user entity to process, then the operational flow returns to block 503. Otherwise, the operations of FIG. 5 ends.

### Variations

Embodiments can also incorporate feedback on indication of inferred user owners to adjust weights, data sources, and/or properties. Based on feedback, a common property can be deemed as injecting noise or not being helpful when incorrectly identified contacts have a common property (e.g., members of a same group or common role). The owner inference module can be integrated with a communication application (e.g., a chat application) for both outgoing notification to inferred owners and to collect confirmation or denial of ownership. This feedback can guide modification of verbs, properties, weights, etc.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, quantum, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

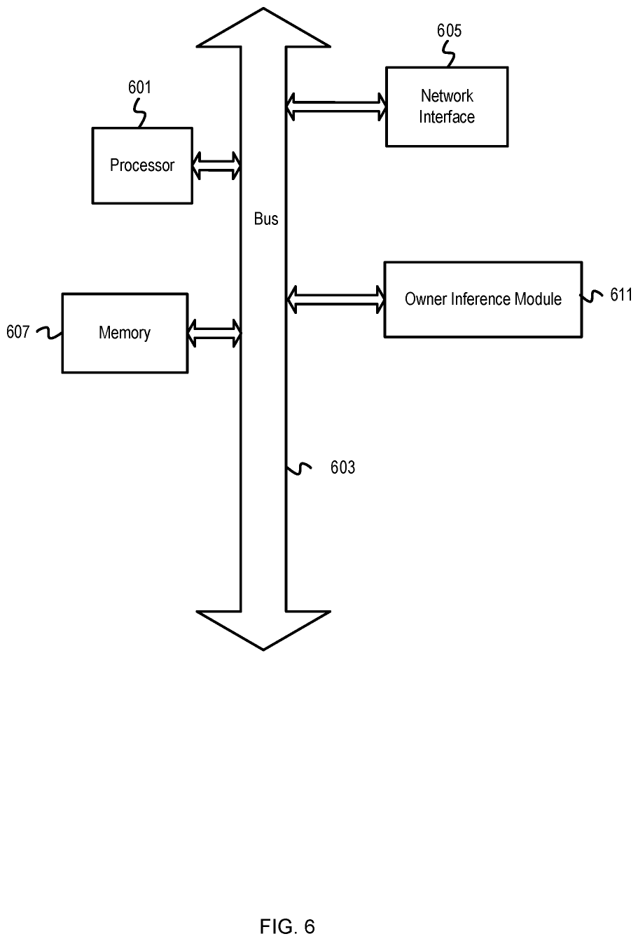

FIG. 6 depicts an example computer system with an owner inference module. The computer system includes a processor 601 (possibly including multiple processors, multiple cores, multiple nodes, and/or implementing multi-threading, etc.). The computer system includes memory 607. The memory 607 may be system memory or any one or more of the above already described possible realizations of machine-readable media. The computer system also includes a bus 603 and a network interface 605. The system also includes an owner inference module 611. The owner inference module 611 queries data sources of an organization to obtain information that can be analyzed to identify entities related in some way to an asset discovered from scanning for external-facing assets. The owner inference module 611 stores related entities and information about the relationships in a relationship structure and then extracts relationship property values from the relationship structure in a scoring structure to score likelihood of ownership for each user entity. Any one of the previously described functionalities may be partially (or entirely) implemented in hardware and/or on the processor 601. For example, the functionality may be implemented with an application specific integrated circuit, in logic implemented in the processor 601, in a co-processor on a peripheral device or card, etc. Further, realizations may include fewer or additional components not illustrated in FIG. 6 (e.g., video cards, audio cards, additional network interfaces, peripheral devices, etc.). The processor 601 and the network interface 605 are coupled to the bus 603. Although illustrated as being coupled to the bus 603, the memory 607 may be coupled to the processor 601.

### Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

1. A method comprising:
submitting a first set of one or more queries to a first set of one or more systems for information about an asset which is Internet-facing;
analyzing responses to the first set of queries to identify a first set of entities having direct relationships with the asset and constructing a graph of the direct relationships with indications of properties of the direct relationships based, at least in part, on the first set of queries and the responses to the first set of queries;
for each entity of a first subset of the first set of entities that is not an individual contact,
submitting a second set of one or more queries to a second set of one or more systems for information about the entity, wherein the first and second set of systems can overlap or be the same; and
analyzing responses to the second set of queries to identify a second set of one or more entities having indirect relationships with the asset via the entity; and
updating the graph to indicate the indirect relationships and properties of the indirect relationships based on the second set of queries and the responses to the second set of queries;
for each of the identified entities that is a contact, scoring likelihood of ownership of the asset based, at least in part, on values of the properties of the one or more relationships the contact has with the asset; and
indicating a set of the contacts as likely owners of the asset based, at least in part, on the scoring.

2. The method of claim 1 further comprising determining contact information for each of the set of contacts, wherein indicating the set of contacts comprises indicating the contact information of the set of contacts.

3. The method of claim 1, wherein analyzing responses to the first set of queries to identify the first set of entities having direct relationships with the asset comprises identifying the first set of entities indicated in the responses to the first set of queries and determining that the first set of entities have relationships with the asset based on relationship verbs determined from at least one of the responses to the first set of queries, parameters of the first set of queries, and attributes of the plurality of systems.

4. The method of claim 3, wherein a relationship verb is an explicit verb or an implicit verb that indicates a relationship, wherein an explicit verb is a keyword or tag in a query response that explicitly relates an entity to an asset and an implicit verb is at least one of a query parameter, a system attribute, a role indicated in a query response, and a permission indicated in a query response that implies a relationship between an entity and an asset.

5. The method of claim 1, wherein scoring, for each identified entity that is a contact, likelihood of ownership of the asset based, at least in part, on the properties of the one or more relationships the contact has with the asset comprises quantifying an aggregate of the values of the properties of the one or more relationships the contact has with the asset.

6. The method of claim 5, wherein quantifying, for each identified entity that is a contact, an aggregate of the values of the properties of the one or more relationships the contact has with the asset comprises weighing at least one of the properties and then aggregating of the values of the properties.

7. The method of claim 1, wherein the properties of relationships comprise at least two of number of relationships a contact has with the asset, number of different types of relationships a contact has with the asset, commonality between attribute of the contact and an attribute of the asset, minimum relationship distance the contact has with the asset, and attribute of the one or more of the systems providing a response from which a relationship was determined.

8. The method of claim 1 further comprising:
separately ranking those of the contacts that are group contacts and those of the contacts that are individual contacts according to their scores; and
adjusting scores of group contacts based, at least in part, on scores of the individual contacts according to group membership.

9. A non-transitory, machine-readable medium having program code stored thereon, the program code comprising instructions to:
determine data sources to query for an external-facing asset of an organization;
query the data sources about the asset and analyze responses to identify entities related to the external-facing asset up to a defined distance limit and to determine properties of the relationships;
for each of the identified entities that is a contact,
analyze properties of the one or more relationships the contact has with the external-facing asset to determine values of the properties;
quantify likelihood of ownership based on an aggregate of the values of the properties; and
indicate as likely owners of the external-facing asset a set of the contacts based, at least in part, on quantified likelihood of ownership.

10. The non-transitory machine-readable medium of claim 9, wherein the instructions to analyze responses to identify entities related to the external-facing asset up to the defined distance limit and to determine properties of the relationships comprise instructions to:
identify one or more of the entities related to the external-facing asset in those of the responses from a first subset of the data sources according to known structure of responses from the subset of the data sources;
identify as a possible identifier of an entity a term in those of the responses from a second subset of the data sources based on natural language processing of those of the responses from the second subset of the data sources and query the second subset or a third subset of the data sources with the term; and
analyze the one or more responses to the query or queries with the term for transactional language that indicates the term and the external-facing asset to determine existence of a relationship.

11. The non-transitory machine-readable medium of claim 9, wherein the program code further comprises instructions to create a graph indicating the identified entities, the relationships, and the properties of the relationships, wherein the instructions to, for each contact, analyze properties of each relationship the contact has with the external-facing asset to determine values of properties comprise the instructions to determine the values of the properties from the graph.

12. The non-transitory machine-readable medium of claim 11, wherein the instructions to, for each contact, analyze properties of each relationship the contact has with the external-facing asset to determine values of properties comprise the instructions to determine at least two of a number of relationships the contact has with the asset, minimum relationship distance the contact has with the external-facing asset, and type of each relationship the contact has with the external-facing asset.

13. The non-transitory machine-readable medium of claim 11, wherein the instructions to, for each contact, quantify likelihood of ownership based on an aggregate of the values of the properties comprise instructions to weigh at least one of the property values before aggregating.

14. The non-transitory machine-readable medium of claim 9, wherein the program code further comprises instructions to:
separately rank those of the contacts that are group contacts and those of the contacts that are individual contacts according to their quantified likelihood of ownership; and
adjust quantified likelihood of ownership of the group contacts based, at least in part, on quantified likelihood of ownership of the individual contacts according to group membership.

15. An apparatus comprising:
a processor; and
a machine-readable medium having instructions stored thereon that are executable by the processor to cause the apparatus to,
determine data sources to query for an external-facing asset of an organization;
query the data sources about the asset and analyze responses to identify entities related to the external-facing asset up to a defined distance limit and to determine properties of the relationships;
for each of the identified entities that is a contact,
analyze properties of the one or more relationships the contact has with the external-facing asset to determine values of the properties;
quantify likelihood of ownership based on an aggregate of the values of the properties; and
indicate as likely owners of the external-facing asset a set of the contacts based, at least in part, on quantified likelihood of ownership.

16. The apparatus of claim 15, wherein the instructions to analyze responses to identify entities related to the external-facing asset up to the defined distance limit and to determine properties of the relationships comprise instructions executable by the processor to cause the apparatus to:
identify one or more of the entities related to the external-facing asset in those of the responses from a first subset of the data sources according to known structure of responses from the subset of the data sources;
identify as a possible identifier of an entity a term in those of the responses from a second subset of the data sources based on natural language processing of those of the responses from the second subset of the data sources and query the second subset or a third subset of the data sources with the term; and
analyze the one or more responses to the query or queries with the term for transactional language that indicates the term and the external-facing asset to determine existence of a relationship.

17. The apparatus of claim 15, wherein the machine-readable medium further has stored thereon instructions executable by the processor to cause the apparatus to create a graph indicating the identified entities, the relationships, and the properties of the relationships, wherein the instructions to, for each contact, analyze properties of each relationship the contact has with the external-facing asset to determine values of properties comprise the instructions to determine the values of the properties from the graph.

18. The apparatus of claim 17, wherein the instructions to, for each contact, analyze properties of each relationship the contact has with the external-facing asset to determine values of properties comprise the instructions being executable by the processor to cause the apparatus to determine at least two of a number of relationships the contact has with the asset, minimum relationship distance the contact has with the external-facing asset, and type of each relationship the contact has with the external-facing asset.

19. The apparatus of claim 18, wherein the instructions to, for each contact, quantify likelihood of ownership based on an aggregate of the values of the properties comprise instructions executable by the processor to cause the apparatus to weigh at least one of the properties values before aggregating.

20. The apparatus of claim 16, wherein the machine-readable medium further has stored thereon instructions executable by the processor to cause the apparatus to:
separately rank those of the contacts that are group contacts and those of the contacts that are individual contacts according to their quantified likelihood of ownership; and
adjust quantified likelihood of ownership of the group contacts based, at least in part, on quantified likelihood of ownership of the individual contacts according to group membership.
